(19) United States
(12) Patent Application Publication
(10) Pub. No.: US 2013/0162806 A1
(43) Pub. Date: Jun. 27, 2013

(54) ENHANCED EDGE FOCUS TOOL

(71) Applicants: Yuhua Ding, Kirkland, WA (US); Shannon Roy Campbell, Woodinville, WA (US); Mark Lawrence Delaney, Shoreline, WA (US); Robert Kamil Bryll, Bothell, WA (US)

(72) Inventors: Yuhua Ding, Kirkland, WA (US); Shannon Roy Campbell, Woodinville, WA (US); Mark Lawrence Delaney, Shoreline, WA (US); Robert Kamil Bryll, Bothell, WA (US)

(73) Assignee: MITUTOYO CORPORATION, Kawasaki-shi (JP)

(21) Appl. No.: 13/336,938

(22) Filed: Dec. 23, 2011

(51) Int. Cl. G06K 9/00; H04N 7/18

(52) U.S. Cl. 348/86; 382/152; 348/E07.085

(57) ABSTRACT

A method for operating an edge focus tool to focus the optics of a machine vision inspection system proximate to an edge adjacent to a beveled surface feature is provided. The method comprises defining a region of interest (ROI) including the edge in a field of view of the machine vision inspection system; acquiring an image stack of the ROI over a Z range including the edge; generating a point cloud including a Z height for a plurality of points in the ROI, based on determining a best focus Z height measurement for the plurality of points; defining a proximate subset of the point cloud comprising points proximate to the beveled surface feature and corresponding to the shape of the beveled surface feature; defining a Z-extremum subset of the proximate subset of the point cloud; and focusing the optics at a Z height corresponding to the Z-extremum subset.

### FIELD OF THE INVENTION

The invention relates generally to machine vision inspection systems, and more particularly to methods of focusing a machine vision inspection system at an edge adjacent to a beveled surface.

### BACKGROUND OF THE INVENTION

Precision machine vision inspection systems (or “vision systems” for short) can be utilized to obtain precise dimensional measurements of inspected objects and to inspect various other object characteristics. Such systems may include a computer, a camera and optical system, and a precision stage that is movable in multiple directions to allow workpiece inspection. One exemplary prior art system, that can be characterized as a general-purpose “off-line” precision vision system, is the commercially-available QUICK VISION® series of PC-based vision systems and QVPAK® software available from Mitutoyo America Corporation (MAC), located in Aurora, Ill. The features and operation of the QUICK VISION® series of vision systems and the QVPAK® software are generally described, for example, in the QVPAK 3D CNC Vision Measuring Machine User's Guide, published January 2003, and the QVPAK 3D CNC Vision Measuring Machine Operation Guide, published September 1996, each of which is hereby incorporated by reference in their entirety. This type of system is able to use a microscope-type optical system and move the stage so as to provide inspection images of either small or relatively large workpieces at various magnifications. General purpose precision machine vision inspection systems, such as the QUICK VISION™ system, are also generally programmable to provide automated video inspection. Such systems typically include GUI features and predefined image analysis “video tools” such that operation and programming can be performed by “non-expert” operators. For example, U.S. Pat. No. 6,542,180, which is incorporated herein by reference in its entirety, teaches a vision system that uses automated video inspection including the use of various video tools.

It is known to use autofocus methods and autofocus video tools (tools, for short) to assist with focusing a machine vision system. For example, the previously cited QVPAK® software includes such methods as autofocus video tools. Autofocusing is also discussed in “Robust Autofocusing in Microscopy,” by Jan-Mark Geusebroek and Arnold Smeulders in ISIS Technical Report Series, Vol. 17, November 2000, in U.S. Pat. No. 5,790,710, and in commonly assigned U.S. Pat. No. 7,030,351, and commonly assigned U.S. Pre-Grant Publication No. 20100158343, each of which is incorporated herein by reference, in its entirety. In one known method of autofocusing, the camera moves through a range of positions or imaging heights along a Z-axis and captures an image at each position (referred to as an image stack). For a desired region of interest in each captured image, a focus metric (e.g., a contrast metric) is calculated and related to the corresponding position of the camera along the Z-axis at the time that the image was captured. The focus metric for an image may be determined in real time, and the image may then be discarded from a system memory as needed. A focus curve based on this data, that is a curve that plots the contrast metric value as a function Z height, exhibits a peak at the best focus height (simply referred to as the focus height). A focus curve may be fit to the data to estimate the focus height with a resolution that is better than the spacing between Z heights of the data points. This type of autofocus, which is used in various known autofocus tools, is not suitable for focusing on an edge located adjacent to a beveled surface feature because different portions of the bevel are in focus and out of focus in different images of the image stack, and as a result, the focus curve has a broader peak, or a poorly defined peak such that the accuracy and repeatability of autofocus under these circumstances is problematic.

Various methods are known for focusing on edge features in workpiece images. For example, the previously cited QVPAK® software includes an edge focus tool which looks for a focus height in a stack of images that maximizes the gradient across an edge feature of a workpiece. However, that edge focus tool is unsuitable for reliably focusing on an edge adjacent to a beveled surface feature. As noted above, different portions of the bevel are in focus and out of focus in different images of the image stack. For various workpiece configurations, this influences the gradient unpredictably in various images. Furthermore, the workpiece may not include any material beyond the edge adjacent to the beveled surface feature, i.e., that edge is the end of the workpiece, or a workpiece surface on that side may fall outside of the range of a practical image stack such that the gradient may have unpredictable characteristics which will cause the edge focus tool to fail. Thus, edge features located near a beveled surface feature have proven difficult for known implementations of autofocus; thus, a new approach is required. As used herein, the term “beveled surface feature” refers to a surface which is not parallel to an imaging plane of a machine vision inspection system. A beveled surface may often extend beyond the depth of focus of the machine vision inspection system. A beveled surface feature may have a simple planar shape inclined relative to the imaging plane or a more complex curved shape. One type of beveled surface feature may commonly be referred to as a chamfer. Focus operations near an edge of such a feature are often unreliable and may be prone to failure, as outlined above. Autofocus operations on a flat surface approximately parallel to the image plane of a machine vision system tend to provide a single distinct focus peak. However, when a surface is tilted or curved relative to the image plane, e.g., along a chamfered edge of a workpiece, a poor quality, broad focus curve may be provided which is not suitable for reliable focus operations. In addition, due to effects of lighting reflected along an edge adjacent to a bevel, conventional autofocus measurements (e.g., contrast or gradient measurements) near such an edge may behave unpredictably. An improved method for focusing the optics of a machine vision inspection system at an edge proximate to a beveled surface is desirable.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method is provided for operating an edge focus tool included in a machine vision inspection system to focus the optics of the machine vision inspection system proximate to an edge located adjacent to a beveled surface feature. In some cases, the edge may be an edge or boundary of the beveled surface feature. The method comprises defining a region of interest (ROI) including the edge adjacent to the beveled surface feature in a field of view of the machine vision inspection system; acquiring an image stack of the ROI over a Z range including the edge; generating a point cloud including a Z height for a plurality of points in the ROI, based on determining a best focus Z height measurement for the plurality of points; defining a proximate subset of the point cloud comprising points proximate to the beveled surface feature and corresponding to the shape of the beveled surface feature; defining a Z-extremum subset of the proximate subset of the point cloud; and focusing the optics at a Z height corresponding to the Z-extremum subset.

In some embodiments, defining a proximate subset of the point cloud may comprise estimating a surface shape model from the point cloud, the surface shape model corresponding to the shape of the beveled surface feature; and excluding points of the point cloud which deviate from the surface shape model by more than a relationship parameter. In some embodiments, estimating a surface shape model from the point cloud and excluding points of the point cloud may comprise applying one of a RANSAC and an LMS (least median of squares) algorithm to the point cloud. It should be appreciated that any other robust outlier detection and exclusion algorithm may be applied to the point cloud. In some embodiments, the edge tool may comprise a graphical user interface (GUI) which includes a shape selection widget in which a user may select which type of surface shape model is estimated from the point cloud during operations of the edge focus tool. In some embodiments, the surface shape model may comprise one of: a plane, a cone, a cylinder and a sphere. In some embodiments, a user selects the surface shape model during a learn mode of operation.

In some embodiments, defining a proximate subset of the point cloud comprises fitting a surface fit model to the point cloud, the surface fit model corresponding to the shape of the beveled surface feature; and excluding points of the point cloud which deviate from the surface fit model by more than a minimum surface shape parameter.

In some embodiments, the method may further comprise displaying a graphical user interface (GUI) of the edge focus tool in a user interface of the machine vision inspection system and operating the GUI to select the ROI to begin operations of the edge focus tool.

In some embodiments, the ROI may include a portion of the workpiece which is outside of the Z range.

In some embodiments, the Z-extremum subset of the point cloud may comprise the lowest Z heights of the point cloud.

In some embodiments, focusing the optics to the Z height corresponding to the Z-extremum may comprise moving a stage of the machine vision inspection system such that the workpiece is at that Z height.

In some embodiments, focusing the optics at a Z height corresponding to the Z-extremum subset may comprise focusing the optics at a Z height of a point with a Z height which is one of: a median, an average, and a mode of the Z-extremum subset of the point cloud.

In some embodiments, generating a point cloud may comprise performing autofocus operations for a plurality of sub-ROIs within the ROI, each sub-ROI comprising a subset of pixels of the ROI.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram showing various typical components of a general purpose precision machine vision inspection system;

FIG. 2 is a block diagram of a control system portion and a vision components portion of a machine vision inspection system similar to that of FIG. 1, and including features according to this invention;

FIG. 3 shows a field of view in a user interface of a machine vision inspection system including a region of interest indicator associated with an edge focus tool;

FIG. 4 shows a cross section view of a beveled edge feature of a workpiece;

FIG. 5 shows a closeup of the cross section view of the beveled edge feature shown in FIG. 4; and

FIG. 6 is a flow diagram illustrating one embodiment of a general routine for operating an edge focus tool to focus the optics of a machine vision inspection system proximate to an edge adjacent to a beveled surface.

### DETAILED DESCRIPTION OF THE PREFERRED EMBODIMENT

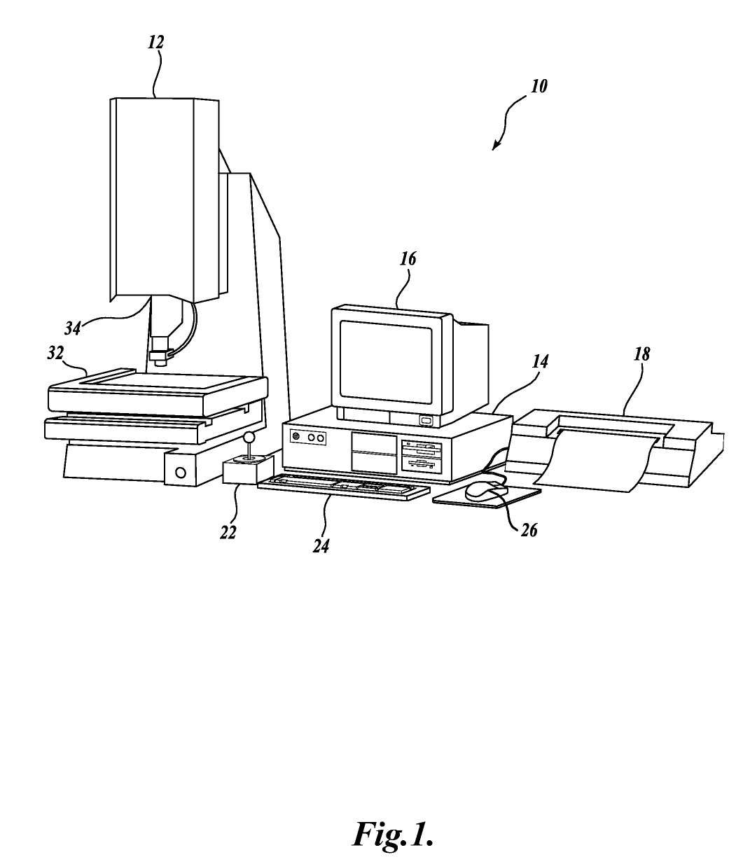

FIG. 1 is a block diagram of one exemplary machine vision inspection system 10 usable in accordance with methods described herein. The machine vision inspection system 10 includes a vision measuring machine 12 that is operably connected to exchange data and control signals with a controlling computer system 14. The controlling computer system 14 is further operably connected to exchange data and control signals with a monitor or display 16, a printer 18, a joystick 22, a keyboard 24, and a mouse 26. The monitor or display 16 may display a user interface suitable for controlling and/or programming the operations of the machine vision inspection system 10.

The vision measuring machine 12 includes a moveable workpiece stage 32 and an optical imaging system 34 which may include a zoom lens or interchangeable lenses. The zoom lens or interchangeable lenses generally provide various magnifications for the images provided by the optical imaging system 34. The machine vision inspection system 10 is generally comparable to the QUICK VISION® series of vision systems and the QVPAK® software discussed above and similar state-of-the-art commercially available precision machine vision inspection systems. The machine vision inspection system 10 is also described in commonly assigned U.S. Pat. No. 7,454,053, U.S. Pat. No. 7,324,682, U.S. Pre-Grant Publication No. 20100158343, and U.S. Pre-Grant Publication No. 20110103679, which are each incorporated herein by reference in their entireties.

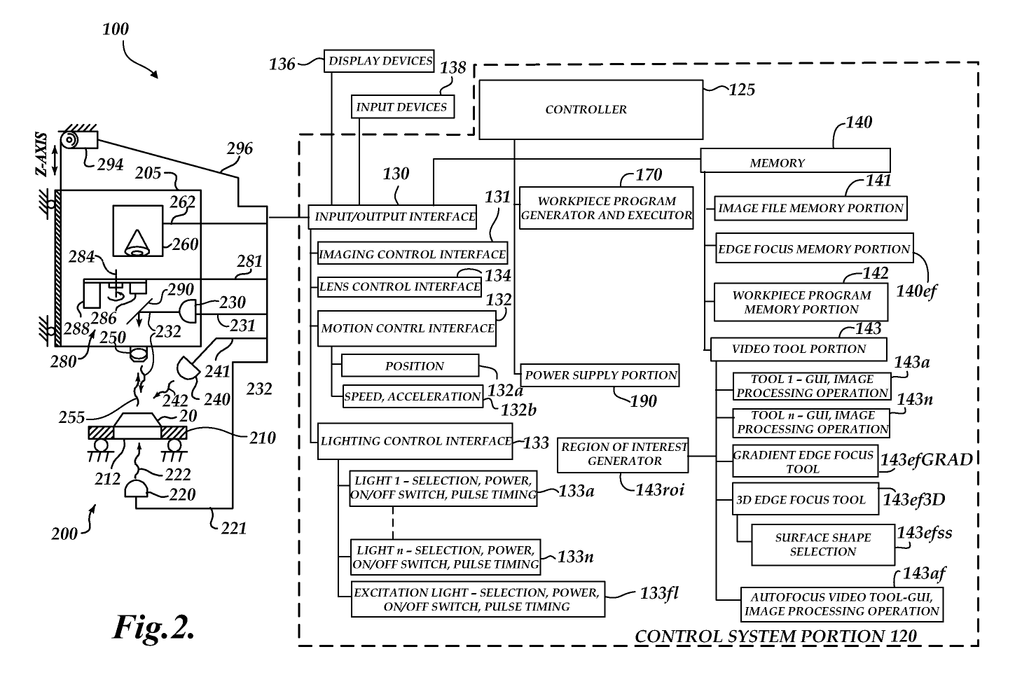

FIG. 2 is a block diagram of a control system portion 120 and a vision components portion 200 of a machine vision inspection system 100 similar to the machine vision inspection system of FIG. 1, and including features according to this invention. As will be described in more detail below, the control system portion 120 is utilized to control the vision components portion 200. The vision components portion 200 includes an optical assembly portion 205, light sources 220, 230, and 240, and a workpiece stage 210 having a central transparent portion 212. The workpiece stage 210 is controllably movable along X and Y axes that lie in a plane that is generally parallel to the surface of the stage where a workpiece 20 may be positioned. The optical assembly portion 205 includes a camera system 260, an interchangeable objective lens 250, and may include a turret lens assembly 280 having lenses 286 and 288. Alternatively to the turret lens assembly, a fixed or manually interchangeable magnification-altering lens, or a zoom lens configuration, or the like, may be included.

The optical assembly portion 205 is controllably movable along a Z-axis that is generally orthogonal to the X and Y axes, by using a controllable motor 294 that drives an actuator to move the optical assembly portion 205 along the Z-axis to change the focus of the image of the workpiece 20. The controllable motor 294 is connected to the input/output interface 130 via a signal line 296.

A workpiece 20, or a tray or fixture holding a plurality of workpieces 20, which is to be imaged using the machine vision inspection system 100 is placed on the workpiece stage 210. The workpiece stage 210 may be controlled to move relative to the optical assembly portion 205, such that the interchangeable objective lens 250 moves between locations on a workpiece 20, and/or among a plurality of workpieces 20. One or more of a stage light 220, a coaxial light 230, and a surface light 240 (e.g., a ring light) may emit source light 222, 232, and/or 242, respectively, to illuminate the workpiece or workpieces 20. The light source 230 may emit light 232 along a path including a minor 290. The source light is reflected or transmitted as workpiece light 255, and the workpiece light used for imaging passes through the interchangeable objective lens 250 and the turret lens assembly 280 and is gathered by the camera system 260. The image of the workpiece(s) 20, captured by the camera system 260, is output on a signal line 262 to the control system portion 120. The light sources 220, 230, and 240 may be connected to the control system portion 120 through signal lines or buses 221, 231, and 241, respectively. To alter the image magnification, the control system portion 120 may rotate the turret lens assembly 280 along axis 284 to select a turret lens, through a signal line or bus 281.

As shown in FIG. 2, in various exemplary embodiments, the control system portion 120 includes a controller 125, the input/output interface 130, a memory 140, a workpiece program generator and executor 170, and a power supply portion 190. Each of these components, as well as the additional components described below, may be interconnected by one or more data/control buses and/or application programming interfaces, or by direct connections between the various elements.

The input/output interface 130 includes an imaging control interface 131, a motion control interface 132, a lighting control interface 133, and a lens control interface 134. The motion control interface 132 may include a position control element 132a, and a speed/acceleration control element 132b, although such elements may be merged and/or indistinguishable. The lighting control interface 133 includes lighting control elements 133a-133n and 133fl which control, for example, the selection, power, on/off switch, and strobe pulse timing, if applicable, for the various corresponding light sources of the machine vision inspection system 100.

The memory 140 may include an image file memory portion 141, an edge focus memory portion 140ef described in greater detail below, a workpiece program memory portion 142 that may include one or more part programs, or the like, and a video tool portion 143. The video tool portion 143 includes video tool portion 143a and other video tool portions (e.g., 143n), which determine the GUI, image processing operation, etc., for each of the corresponding video tools, and a region of interest (ROI) generator 143roi that supports automatic, semi-automatic and/or manual operations that define various ROIs that are operable in various video tools included in the video tool portion 143.

In the context of this disclosure, and as known by one of ordinary skill in the art, the term video tool generally refers to a relatively complex set of automatic or programmed operations that a machine vision user can implement through a relatively simple user interface (e.g., a graphical user interface, editable parameter windows, menus, and the like), without creating the step-by-step sequence of operations included in the video tool or resorting to a generalized text-based programming language, or the like. For example, a video tool may include a complex pre-programmed set of image processing operations and computations which are applied and customized in a particular instance by adjusting a few variables or parameters that govern the operations and computations. In addition to the underlying operations and computations, the video tool comprises the user interface that allows the user to adjust those parameters for a particular instance of the video tool. For example, many machine vision video tools allow a user to configure a graphical region of interest (ROI) indicator through simple “handle dragging” operations using a mouse, in order to define the location parameters of a subset of an image that is to be analyzed by the image procession operations of a particular instance of a video tool. It should be noted that the visible user interface features are sometimes referred to as the video tool, with the underlying operations being included implicitly.

In common with many video tools, the edge focus subject matter of this disclosure includes both user interface features and underlying image processing operations, and the like, and the related features may be characterized as features of a 3D edge focus tool 143ef3D included in the video tool portion 143. The 3D edge focus tool 143ef3D provides operations which may be used to focus the imaging portion 200 of the machine vision inspection system 100 proximate to an edge adjacent to a beveled surface feature. In particular, the 3D edge focus tool 143ef3D may be used to determine a Z height for focusing the optics of the machine vision inspection system 100 for performing edge detection operations to determine the location of the edge adjacent to the beveled surface feature. In one embodiment, the 3D edge focus tool 143ef3D may include a surface shape selection portion 143efss that provides an option for a type of surface shape model to estimate from data associated with a beveled surface feature according to a particular shape, e.g., a plane, a cone, a sphere, or a cylinder. 3D edge focus tool parameters may be determined and stored in a part program during learn mode operations, as described in greater detail below. The focus Z height determined by the 3D edge focus tool 143ef3D, and/or shape data related to the beveled surface adjacent to the edge may be stored by an edge focus memory portion 140ef for future use, in some embodiments. The video tool portion 143 may also include a gradient edge focus tool 143efGRAD which operates according to known autofocus methods which find a focus height which provides the strongest gradient across an edge. Briefly, the edge gradient focus tool 143efGRAD may comprise the operations of: defining a region of interest (ROI) including an edge feature in a field of view of a machine vision inspection system; acquiring an image stack of the ROI over a Z range including the edge; determining a set of image intensity gradients across the edge for the image stack; and focusing the optics at a Z height which provides the strongest gradient in the image stack. The video tool portion 143 may also include a conventional surface autofocus video tool 143af, which may provide autofocus operations for approximately planar surfaces parallel to the image plane of a vision system, for example. In one embodiment, the 3D edge focus tool 143ef3D may be linked or otherwise act in conjunction with certain known autofocus tools (e.g., the gradient edge focus tool, or the surface autofocus tool) or operations (e.g., region of interest contrast computations, focus curve data determination and storage, focus curve peak finding, etc.). For example, in one embodiment, the 3D edge focus tool operations disclosed herein may be included as a focus mode in a multi-mode autofocus tool that includes modes comparable to the gradient edge focus tool, or the surface autofocus tool. In some embodiments, the 3D edge focus tool 143ef3D and the gradient edge focus tool 143efGRAD may be separate tools, but in some embodiments they may be two modes of a single edge focus tool. In some embodiments where they are two modes of a single edge focus tool, the particular mode may automatically be chosen by the edge tool based on learn mode operations described further below.

The signal lines or buses 221, 231 and 241 of the stage light 220, the coaxial lights 230 and 230′, and the surface light 240, respectively, are all connected to the input/output interface 130. The signal line 262 from the camera system 260 and the signal line 296 from the controllable motor 294 are connected to the input/output interface 130. In addition to carrying image data, the signal line 262 may carry a signal from the controller 125 that initiates image acquisition.

One or more display devices 136 (e.g., the display 16 of FIG. 1) and one or more input devices 138 (e.g., the joystick 22, keyboard 24, and mouse 26 of FIG. 1) can also be connected to the input/output interface 130. The display devices 136 and input devices 138 can be used to display a user interface, which may include various graphical user interface (GUI) features that are usable to perform inspection operations, and/or to create and/or modify part programs, to view the images captured by the camera system 260, and/or to directly control the vision system components portion 200. The display devices 136 may display user interface features associated with the 3D edge focus tool 143ef3D, described in greater detail below.

In various exemplary embodiments, when a user utilizes the machine vision inspection system 100 to create a part program for the workpiece 20, the user generates part program instructions by operating the machine vision inspection system 100 in a learn mode to provide a desired image acquisition training sequence. For example, a training sequence may comprise positioning a particular workpiece feature of a representative workpiece in the field of view (FOV), setting light levels, focusing or autofocusing, acquiring an image, and providing an inspection training sequence applied to the image (e.g., using an instance of one of the video tools on that workpiece feature). The learn mode operates such that the sequence(s) are captured or recorded and converted to corresponding part program instructions. These instructions, when the part program is executed, will cause the machine vision inspection system to reproduce the trained image acquisition and inspection operations to automatically inspect that particular workpiece feature (that is, the corresponding feature in the corresponding location) on a run mode workpiece or workpieces which match the representative workpiece used when creating the part program.

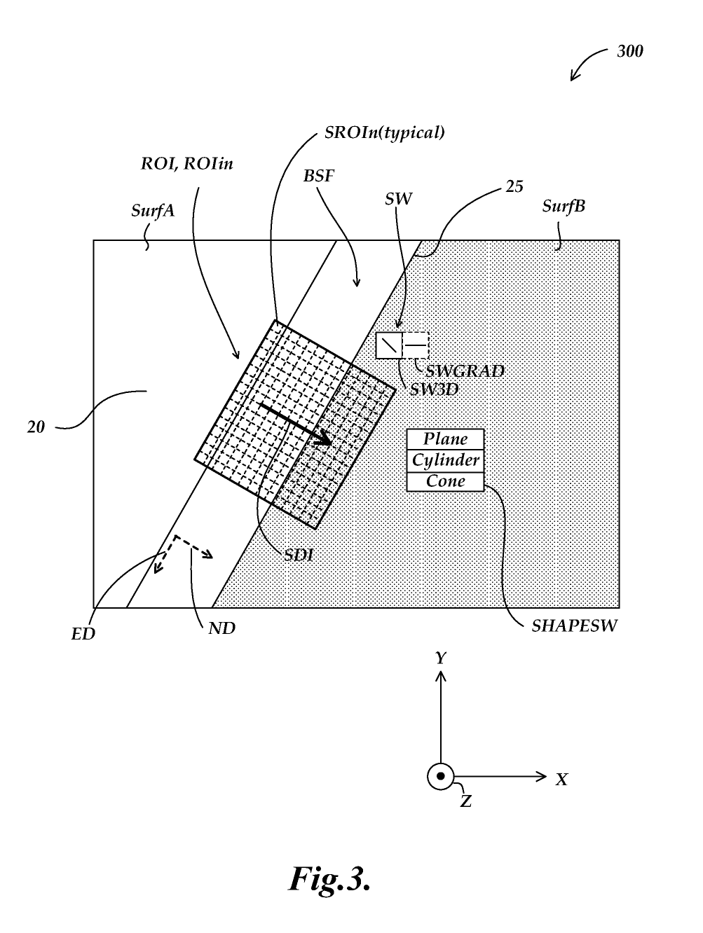

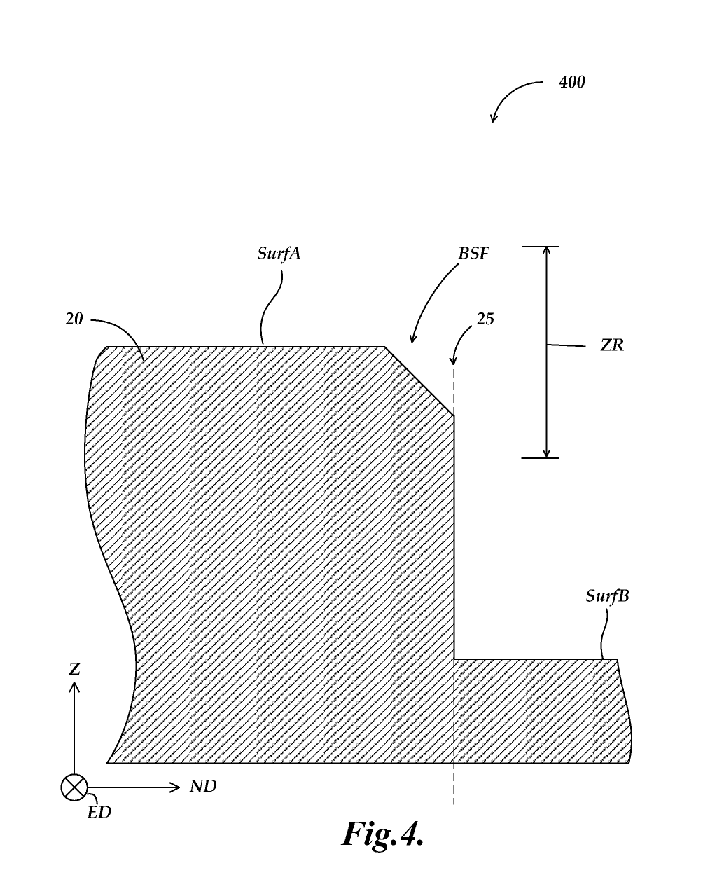

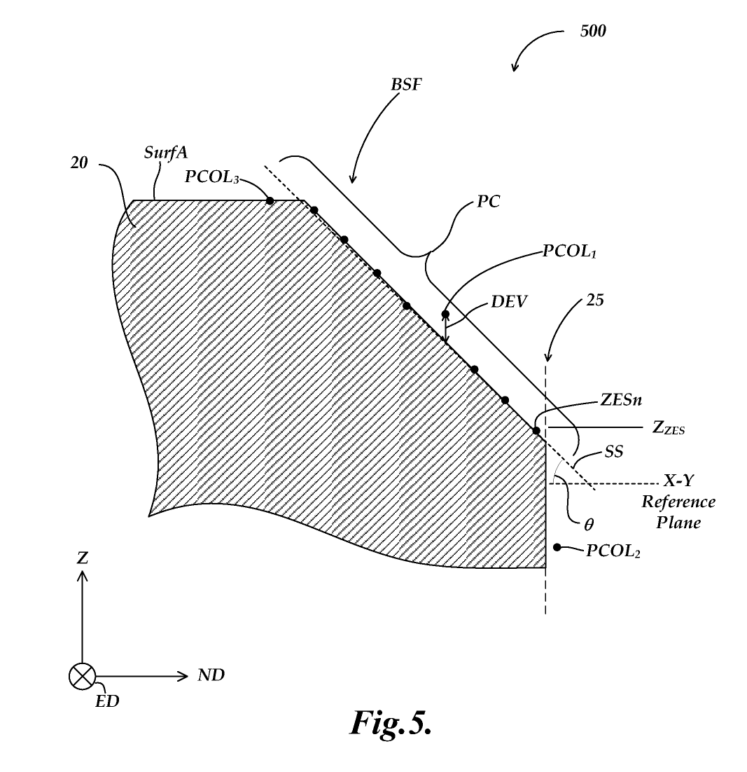

FIG. 3 shows an imaged field of view 300 in a user interface of the machine vision inspection system 100 including a region of interest indicator ROIin associated with the 3D edge focus video tool 143ef3D. In various embodiments of operations for determining the location of an edge 25 of a beveled surface feature BSF of a workpiece 20, the beveled surface feature BSF of the workpiece 20 is positioned in the field of view 300 of the machine vision inspection system 100. The edge 25, as shown in FIG. 3, is an edge between a surface SurfA and a surface SurfB. In some applications or implementations, surface SurfB may be a void (e.g., beyond the limits of the workpiece 20). The surface SurfA has a greater Z height than the surface SurfB as will be shown in further detail with respect to FIG. 4 and FIG. 5. The 3D edge focus tool 143ef3D is configured to define a region of interest ROI using a user interface associated with the 3D edge focus video tool 143ef3D in conjunction with the region of interest generator 143roi and displayed with the region of interest indicator ROIin. The region of interest ROI may be indicated by a region of interest indicator ROIin in the user interface. The region of interest ROI may generally be configured and aligned during a learn mode of the vision system by a user selecting an icon representing the 3D edge focus tool 143ef3D on a tool bar of the user interface, whereupon the region of interest indicator ROIin appears overlaying a workpiece image in the user interface. The user may then drag sizing and/or rotation handles (not shown) that appear when the region of interest tool is first implemented (e.g., as occurs with known commercially-available machine vision inspection system video tools). Alternatively, the user may edit numerical size and position parameters. The user configures the region of interest indicator ROIin to be at a desired location such that it includes the edge 25, and sizes the region of interest indicator ROIin to include a portion of the beveled surface feature BSF using sizing or the like. For purpose of discussion, we define an edge direction, labeled ED in FIG. 3, which extends approximately parallel to the edge 25. We also define a normal direction ND, which is normal to the edge direction ED. In many applications, the beveled surface feature BSF slopes downward toward the surface SurfB approximately along the normal direction ND. In various embodiments, the 3D edge focus tool may include a scan direction indicator SDI located in the region of interest indicator ROIin. In some such embodiments, during learn mode the user may adjust the alignment of the region of interest indicator ROIin such that the scan direction indicator SDI extends generally along the direction ND and crosses the edge 25. In some embodiments, the 3D edge focus tool 143ef3D may use associated parameters derived from such an alignment configuration to optimize surface shape model estimation and edge selection operations described further below, or set limits used to insure robustness of autofocus results, or the like.

The operations of the 3D edge focus tool 143ef3D generate a point cloud, which comprises a group of points i having defined coordinates (Xi,Yi,Zi), by performing autofocus operations for a plurality of sub-ROIs within the ROI, each sub-ROI comprising a subset of pixels of the ROI. The group of points, in the embodiment shown in FIG. 3, corresponds to a plurality of sub-ROIs SROIn within the region of interest ROI (defined by dashed lines in FIG. 3) which may or may not be displayed in the region of interest indicator ROIin. More specifically, such operations may be performed according to operations described in commonly assigned U.S. Pat. No. 7,570,795, “Multi-Region Autofocus Tool and Mode,” and/or U.S. Pre-Grant Publication No. 2011/0133054, issued to Campbell, which are hereby incorporated by reference in their entirety.

As shown in FIG. 3, the edge 25 is nominally straight and the beveled surface feature BSF is nominally planar. However, it should be appreciated that the 3D edge focus video tool 143ef3D may also be used for focusing on an edge adjacent to a beveled surface feature where the edge is curved, e.g., a beveled surface feature with a conical, spherical, or cylindrical shape. In general, the operations of the 3D edge focus tool 143ef3D may be applied to common shapes of a beveled surface feature according to principles outlined and claimed herein. In some embodiments, a user may select the type of surface shape during a learn mode of operation. In the embodiment shown in FIG. 3, the user interface of the edge focus tool includes a shape selection widget SHAPESW which may appear when the 3D edge focus mode or tool is selected and/or operational. The user may operate the shape selection widget SHAPESW during learn mode to select which surface shape model is estimated from the point cloud during operations of the edge focus tool, e.g., by clicking on a shape selection widget portion PLANE, CYLINDER or CONE. It will be appreciated that these shape selection options are exemplary only and not limiting. It will be appreciated that in other embodiments, the shape selection may be a text-based menu selection, or a general higher order shape capable of conforming to a variety of surfaces may be used as a default or only option. As outlined previously, in some embodiments the 3D edge focus tool 143ef3D and the gradient edge focus tool 143efGRAD may be two modes of a single edge focus tool (e.g., an edge tool selected by a single icon on a tool bar). In the embodiment shown in FIG. 3, the user interface of the video tool includes a selection widget SW which may appear when the video tool is first implemented in the user interface. The user may operate the mode selection widget SW during learn mode to select which mode of operation is used by the edge tool, e.g., by clicking on a 3D selection widget portion SW3D or a grad selection widget portion SWGRAD.

FIG. 4 shows a cross section view 400 of the beveled surface feature BSF (previously shown in FIG. 3) perpendicular to the edge direction ED (along the direction ND). After a region of interest ROI has been defined, the 3D edge focus tool 143ef3D is configured to acquire an image stack of the ROI over a Z range ZR including the edge 25 and at least a portion of the beveled surface feature BSF. As shown in FIG. 4, points along the surface SurfB lie outside of this range. However, in some cases, a workpiece may not have a surface such as SurfB beyond an edge which is similar to edge 25, and such a workpiece may also be addressed by the 3D edge focus tool 143ef3D. The 3D edge focus tool 143ef3D is configured to generate a point cloud including a Z height for a plurality of points in the ROI, based on determining a best focus Z height measurement for the plurality of points, as will be shown in further detail with respect to FIG. 5. The point cloud may be generated according to methods known in the art such as autofocus methods utilizing a contrast metric. It will be appreciated that for points in the ROI that include surface SurfB, generating the coordinates for such points may fail or provide erroneous results because the surface SurfB lies outside of the Z range ZR and therefore the surface SurfB provides no focused image in the image stack over a Z range ZR. Previously known autofocus tools may frequently fail in such cases. However, the 3D edge focus tool methods disclosed herein operate robustly in such cases, which is one of their advantages, particularly for assisting relatively unskilled users in writing robust part programs for such cases.

FIG. 5 shows a closeup of the cross section view of the edge 25 and beveled surface feature BSF of the workpiece 20 shown in FIG. 4. In particular, FIG. 5 shows representative points of a point cloud PC generated by the 3D edge focus tool 143ef3D. FIG. 5 shows one subset of points in the point cloud PC observed in a plane perpendicular to the ED-ND plane. It will be understood that several such subsets of points are generated at different locations along the edge direction ED in the ROI. In some embodiments, the 3D edge focus tool 143ef 3D includes operations configured to estimate a surface shape model SS from the point cloud PC, the surface shape model SS corresponding to the shape of the beveled surface feature BSF. In the embodiment shown in FIG. 5, the surface shape model SS is a plane. In alternative implementations, the surface shape model SS may have a geometry corresponding to the shape of a cone, a cylinder, or a sphere. In some embodiments such as a cone, a cylinder, or a sphere, where surface curvature is small, a plane may be a sufficient first order approximation for determining a Z height to focus the optics of a machine vision inspection system. Various methods for estimating shapes from such point clouds are known to one of ordinary skill in the art and need not be described in detail here. The methods for estimating a surface shape model from the point cloud PC disclosed herein are exemplary only and not limiting.

The operations of the 3D edge focus tool 143ef3D are configured to define a proximate subset of the point cloud comprising points proximate to the beveled surface feature and corresponding to the shape of the beveled surface feature and to define a Z-extremum subset ZES of the proximate subset of the point cloud PC. FIG. 5 shows one such point ZESn of the Z-extremum subset ZES, which in this case is the point having the minimum Z height in the subset of the points PC shown in FIG. 5. It will be understood that other subsets of points generated at different locations along the edge direction ED in the ROI will contribute analogous “minimum Z-height” points ZESn of the Z-extremum subset ZES. In some embodiments, the Z-extremum subset ZES of the point cloud may comprise the lowest Z heights of the point cloud PC. For example, the Z-extremum subset ZES may comprise points with the 5 or 10 lowest Z heights or even the single lowest Z height. In other embodiments, the Z-extremum subset ZES of the point cloud may comprise the highest Z heights of the point cloud PC. For example, an “inner” beveled surface feature may be located at the bottom of a hole and a lower surface may be within a focus range, and a user may desire to focus on an upper surface using the 3D edge focus tool 143ef3D. The 3D edge focus tool 143ef3D is configured to focus the imaging portion 200 at a Z height Zzes corresponding to the Z-extremum subset ZES. In some embodiments, the Z height Zzes may be a median of the Z-extremum subset ZES or in other embodiments an average. In some embodiments, focusing the imaging portion 200 to the Z height Zzes comprises moving a stage of the machine vision inspection system such that it images the workpiece at the Z height Zzes. When the imaging portion 200 has been focused to the Z height Zzes, the machine vision inspection system 100 may effectively and reliably perform edge detection operations to determine a location of the edge 25 or any other inspection operations that require a focus height corresponding to the edge 25 for optimal performance.

In some embodiments, defining a proximate subset of the point cloud comprises: estimating the surface shape model SS from the point cloud PC such that the surface shape model corresponds to the shape of the beveled surface feature and excluding points of the point cloud which deviate from the surface shape model by more than a relationship parameter established for the 3D edge focus tool 143ef3D. Excluding such points (generally regarded as outliers) improves the quality of the Z-extremum subset. In some embodiments, the relationship parameter may be specified by a user, or, in other embodiments, it may be specified in a runtime script. In some embodiments, the relationship parameter may be a specified number times the depth of field of the optical system that is used for imaging. In other embodiments, the relationship parameter may be determined automatically, e.g., based on a standard deviation or median deviation of the point cloud points, or a subset of point cloud points, relative to the initially estimated surface shape model. For example, a point PCOL₁ deviates from the surface shape model SS by a distance DEV along the Z direction which is sufficiently large to discard the point PCOL₁ from proximate subset of the point cloud PC. A point PCOL₂ deviates significantly from the surface shape model SS, as may be expected when measuring Z heights in close proximity to the edge 25 which includes a portion of a workpiece surface outside of the Z range ZR. A point PCOL₃ deviates significantly from the surface shape model SS because it is located on the surface SurfA. Although the point PCOL₃ has been measured accurately, it does not correspond to the beveled surface feature BSF, but the point cloud PC initially includes this point because a region of interest was selected which included a portion of the surface SurfA. Various robust outlier rejection methods such a as the well known RANSAC or LMS algorithms may be used to discard points such as PCOL₁, PCOL₂, and PCOL₃ which may be treated as outliers of the point cloud PC and should be excluded from the proximate subset of the point cloud PC. Removing outliers improves the robustness of estimating a focus Z height Zzes which is proximate to the Z height at the edge 25.

As outlined previously, in some embodiments the 3D edge focus tool 143ef3D and the gradient edge focus tool 143efGRAD may be two modes of a single edge focus tool. In some embodiments, the mode selection may automatically be chosen by the edge focus tool. For example, in one such embodiment, during learn mode, a point cloud may be generated for an edge focus tool ROI without regard to whether it includes a beveled surface or not, and a surface shape model may be estimated from the point cloud. If the surface shape model, or a tangent of the surface shape model along the direction, is inclined more than a minimum predetermined angle θ (e.g., 5 degrees) relative to a reference plane that is parallel to the X-Y plane, then the mode corresponding to the 3D edge focus tool 143ef3D may be selected and recorded as an operating parameter of that instance of the multi-mode edge focus tool. If the surface shape model or tangent of the surface shape model near an edge adjacent to the beveled edge feature is inclined less than the minimum angle θ, then the gradient edge focus tool 143efGRAD may be used. It will be appreciated based on this disclosure that other methods of automatic edge focus mode selection may be used, and this example is exemplary only, and not limiting.

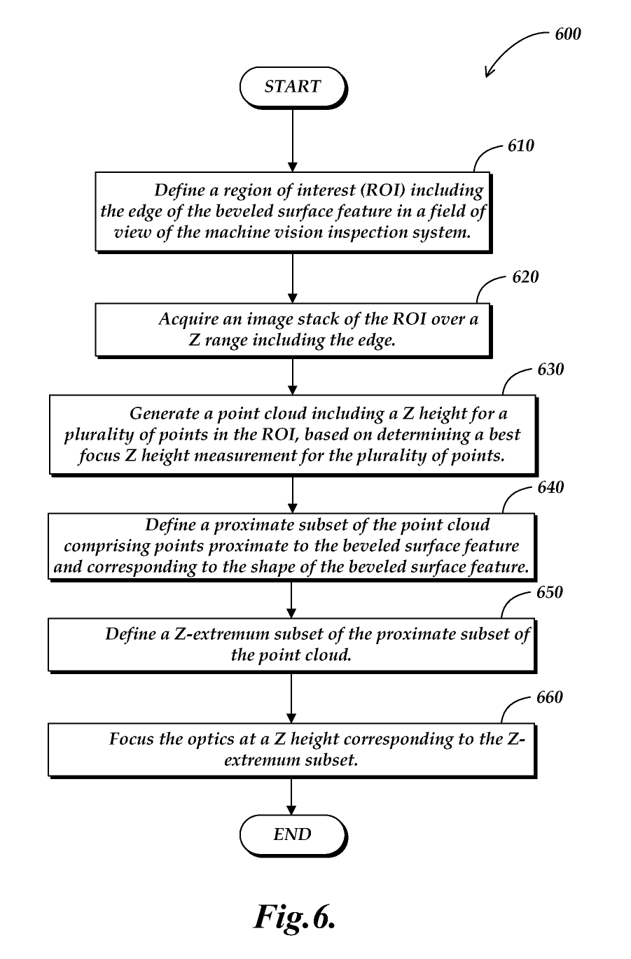

FIG. 6 is a flow diagram illustrating one embodiment of a general routine for operating an edge focus tool (e.g., the 3D edge focus tool 143ef3D) to focus the optics of a machine vision inspection system proximate to an edge (e.g., the edge 25) adjacent to a beveled surface feature (e.g., the beveled surface feature BSF).

At a block 610, a region of interest is defined (ROI) including the edge adjacent to the beveled surface feature in a field of view of the machine vision inspection system. Some embodiments may further comprise the steps of displaying a graphical user interface (GUI) of the edge focus tool in a user interface of the machine vision inspection system and operating the GUI to select the ROI to begin operations of the edge focus tool.

At a block 620, an image stack of the ROI is acquired over a Z range (e.g., the Z range ZR) including the edge.

At a block 630, a point cloud (e.g., the point cloud PC) is generated including a Z height for a plurality of points in the ROI, based on determining a best focus Z height measurement for the plurality of points. In some embodiments, generating a point cloud comprises performing autofocus operations for a plurality of sub-ROIs within the ROI, each sub-ROI comprising a subset of pixels of the ROI.

At a block 640, a proximate subset of the point cloud is defined comprising points proximate to the beveled surface feature and corresponding to the shape of the beveled surface feature. In some embodiments, defining a proximate subset of the point cloud comprises estimating a surface shape model from the point cloud, the surface shape model corresponding to the shape of the beveled surface feature and excluding points of the point cloud which deviate from the surface shape model by more than a minimum surface shape parameter. In some embodiments, estimating a surface shape model from the point cloud to the point cloud and excluding points of the point cloud comprises applying one of a RANSAC and an LMS algorithm to the point cloud. In some embodiments, the edge tool comprises a graphical user interface (GUI) which includes a shape selection widget in which a user may select which type of surface shape model is estimated from the point cloud during operations of the edge focus tool. In some embodiments, the surface shape model comprises one of: a plane, a cone, a cylinder, and a sphere. In some embodiments, a user selects the surface shape model, or more specifically, the type of surface shape model, during a learn mode of operation.

At a block 650, a Z-extremum subset (e.g., the Z-extremum subset ZES) of the proximate subset of the point cloud is defined.

At a block 660, the optics are focused at a Z height (e.g., the Z height Zzes) corresponding to the Z-extremum subset.

While the preferred embodiment of the invention has been illustrated and described, numerous variations in the illustrated and described arrangements of features and sequences of operations will be apparent to one skilled in the art based on this disclosure. Thus, it will be appreciated that various changes can be made therein without departing from the spirit and scope of the invention.

The embodiments of the invention in which an exclusive property or privilege is claimed are defined as follows:

1. A method for operating an edge focus tool included in a machine vision inspection system to focus the optics of the machine vision inspection system proximate to an edge adjacent to a beveled surface feature of a workpiece, the method comprising:
defining a region of interest (ROI) including the edge adjacent to the beveled surface feature in a field of view of the machine vision inspection system;
acquiring an image stack of the ROI over a Z range including the edge;
generating a point cloud including a Z height for a plurality of points in the ROI, based on determining a best focus Z height measurement for the plurality of points;
defining a proximate subset of the point cloud comprising points proximate to the beveled surface feature and corresponding to the shape of the beveled surface feature;
defining a Z-extremum subset of the proximate subset of the point cloud; and
focusing the optics at a Z height corresponding to the Z-extremum subset.

2. The method of claim 1, wherein defining a proximate subset of the point cloud comprises:
estimating a surface shape model from the point cloud, the surface shape model corresponding to the shape of the beveled surface feature; and
excluding points of the point cloud which deviate from the surface shape model by more than a relationship parameter.

3. The method of claim 2, wherein estimating a surface shape model from the point cloud and excluding points of the point cloud comprises applying one of a RANSAC and an LMS algorithm to the point cloud.

4. The method of claim 2, wherein the edge tool comprises a graphical user interface (GUI) which includes a shape selection widget in which a user may select which type of surface shape model is estimated from the point cloud during operations of the edge focus tool.

5. The method of claim 2, wherein the surface shape model comprises one of: a plane, a cone, a cylinder and a sphere.

6. The method of claim 5, wherein a user selects the surface shape model during a learn mode of operation.

7. The method of claim 1, wherein defining a proximate subset of the point cloud comprises:
fitting a surface fit model to the point cloud, the surface fit model corresponding to the shape of the beveled surface feature; and
excluding points of the point cloud which deviate from the surface fit model by more than a minimum surface shape parameter.

8. The method of claim 1, further comprising:
displaying a graphical user interface (GUI) of the edge focus tool in a user interface of the machine vision inspection system; and
operating the GUI to select the ROI to begin operations of the edge focus tool.

9. The method of claim 1, wherein a portion of the ROI includes a portion of the workpiece which is outside of the Z range.

10. The method of claim 1, wherein the Z-extremum subset of the point cloud comprises the lowest Z heights of the point cloud.

11. The method of claim 1, wherein focusing the optics to the Z height corresponding to the Z-extremum comprises moving a stage of the machine vision inspection system such that the workpiece is at that Z height.

12. The method of claim 1, wherein focusing the optics at a Z height corresponding to the Z-extremum subset comprises focusing the optics at a Z height of a point with a Z height which is one of a median, an average, and a mode of the Z-extremum subset of the point cloud.

13. The method of claim 1, wherein generating a point cloud comprises performing autofocus operations for a plurality of sub-ROIs within the ROI, each sub-ROI comprising a subset of pixels of the ROI.

14. A method for operating an edge focus tool to focus the optics of a machine vision inspection system proximate to an edge adjacent to a beveled surface feature, the method comprising:
displaying a graphical user interface (GUI) of the edge focus tool in a user interface of the machine vision inspection system;
operating the GUI to select a region of interest (ROI) including the edge adjacent to the beveled surface feature in a field of view of the machine vision inspection system to begin operations of the edge focus tool; and
operating the edge focus tool to perform the steps of:
acquiring an image stack of the ROI over a Z range including the edge, the ROI including a portion of the field of view where a portion of the workpiece is outside of the Z range;
generating a point cloud including a Z height for a plurality of points in the ROI, based on determining a best focus Z height measurement for the plurality of points;
defining a proximate subset of the point cloud comprising points proximate to the beveled surface feature and corresponding to the shape of the beveled surface feature;
defining a Z-extremum subset of the proximate subset of the point cloud; and
focusing the optics at a Z height corresponding to the Z-extremum subset.

15. An edge focus tool included in a machine vision inspection system, the edge focus tool comprising operations which focus the optics of a machine vision inspection system proximate to an edge adjacent to a beveled surface feature, the edge focus tool comprising a first mode of operation, wherein:
the first mode of operations comprises:
defining a region of interest (ROI) including the edge adjacent to the beveled surface feature in a field of view of the machine vision inspection system;
acquiring an image stack of the ROI over a Z range including the edge;
generating a point cloud including a Z height for a plurality of points in the ROI, based on determining a best focus Z height measurement for the plurality of points;
defining a proximate subset of the point cloud comprising points proximate to the beveled surface feature and corresponding to the shape of the beveled surface feature;
defining a Z-extremum subset of the proximate subset of the point cloud; and
focusing the optics at a Z height corresponding to the Z-extremum subset.

16. The edge focus tool of claim 15, the edge focus tool further comprising a second mode of operation, wherein:
the second mode of operations comprises:
defining a region of interest (ROI) including a edge in a field of view of the machine vision inspection system;
acquiring an image stack of the ROI over a Z range including the edge;
determining a set of image intensity gradients across the edge for the image stack; and
focusing the optics at a Z height which provides the highest gradient in the image stack.

17. The edge focus tool of claim 16, wherein the edge focus tool comprises a widget included in a user interface of the edge focus tool which may be used during a learn mode of the machine vision inspection system to select which of one of the first and second mode of operations will be performed by an instance of the edge focus tool.

18. The edge focus tool of claim 16, wherein the edge focus tool comprises automatic operations performed during a learn mode of the machine vision inspection system to select which of one of the first and second mode of operations will be performed by an instance of the edge focus tool.
